(19) United States
(12) Patent Application Publication
(10) Pub. No.: US 2008/0219685 A1
(43) Pub. Date: Sep. 11, 2008

(54) IMAGE FORMING APPARATUS AND IMAGE FORMING METHOD

(75) Inventor: Masataka Muratani, Akishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/681,868

(22) Filed: Mar. 5, 2007

(51) Int. Cl. G03G 15/00; G06K 15/00

(52) U.S. Cl. 399/45

(57) ABSTRACT

An image forming apparatus according to an embodiment of the invention includes a storing unit configured to store an identification code of an image recording medium and an image forming condition in association with each other, a setting unit configured to set the identification code, and an image forming unit configured to form an image on the basis of the image forming condition associated with the identification code set by the setting unit.

### BACKGROUND OF THE INVENTION

1. Field of the Invention

The present invention relates to image forming apparatuses capable of performing various kinds of image formation such as a copier, a printer, and a facsimile and image forming methods.

2. Description of the Related Art

In recent years, various image forming apparatuses represented by an MFP (multi-function printer) have spread. The MFP can comprehensively treat image data digitized by various functions such as a copier, a printer, a scanner, and a facsimile, store these image data in an HDD, and reuse the image data.

The image forming apparatuses described above start an image recording operation after receiving operation for selecting a type (a sheet size, thickness, etc.) of a recording sheet (an image recording medium). The image forming apparatuses are mounted with plural cassettes. A sheet setting procedure in recording images on recording sheets stored in these cassettes is as described below.
(1) Selection of a cassette
(2) Designation of a size of recording sheets in the cassette
(3) Designation of a type of the recording sheets in the cassette (designation of thick paper, etc.)

In recent years, there is conspicuous tendency to expand a coping range for thick paper and cope with special paper in response to a demand for expanding a coping range for recording sheets. As the coping range for thick paper, for example, specifications such as up to an upper limit of 163 g/m2, up to an upper limit of 256 g/m2, and up to an upper limit of 300 g/m2 are required. There is also conspicuous tendency to generally cope with surface coat paper, label paper, waterproof paper, and the like as special paper.

Even when the thickness and a surface shape of a sheet deviate from standard ranges, in order to maintain satisfactory sheet feeding and a satisfactory recording quality, it is necessary to change setting conditions on an image forming apparatus side according to a recording medium.

When the thickness of a sheet exceeds a range of plain paper (e.g., up to 105 g/m2), image formation is executed under conditions that, for example, a fixing temperature is set higher and process speed is reduced.

It is necessary to cope with the surface coat paper by prohibiting sheet feeding from a normal cassette stage and permitting sheet feeding only from a specific option (LCF: large capacity sheet feeding device).

Moreover, as a sheet feeding method for the surface coat paper with large inter-sheet adhesion, for example, air-assist sheet feeding is known. The air-assist sheet feeding supports separation of sheets by blowing the air from a blower. For appropriate air-assist sheet feeding, selection of an appropriate air quantity, an appropriate air blowing port position, and the like corresponding to a type of the surface coat paper is necessary.

In order to designate a recording medium before starting a recording operation, the following procedure is performed as described above.
(1) Selection of a cassette

Designation of a sheet feeding source including options (including manual feeding and option LCF)
(2) Designation of a size of a recording sheet in the cassette (sheet feeding source)

Designated one size is fixed for one cassette.
(3) Designation of a type of the recording sheet in the cassette (sheet feeding source)

Thin paper designation, thick paper designation, coat paper designation, and the like

It is assumed that plain paper and thick paper are allowed as types of recording sheets that can be fed from the cassette, a range of basis weight of the plain paper is set to 64 g/m2 to 105 g/m2 and a range of basis weight of thick paper 1 is set to 106 g/m2 to 163 g/m2 as apparatus specifications.

A case in which an a brand sheet (85 g/m2) of the A4 size in use in a first cassette is changed to a β brand sheet (125 g/m2) of the A4 size by replacing the sheets in the cassette is assumed.

From a setting menu of an image forming apparatus, a sheet setting screen for the first cassette is displayed and a setting of a sheet type is changed from the plain paper to the thick paper 1 while keeping the A4 size as a setting of a sheet size. According to this setting change, as a result of making recording conditions proper for a basis weight 125 g/m2 of the sheets, appropriate conditions for the recording medium such as a fixing temperature and process speed are automatically selected to make it possible to maintain a satisfactory recording quality.

If the use of the β brand sheet (125 g/m2) of the A4 size is temporary and it is necessary to reset the setting to the α brand sheet (85 g/m2) of the A4 size, it is necessary to reset the setting of the sheet type for the first cassette from the thick paper 1 to the plain paper.

Here, when recording is performed on the plain paper while keeping the thick paper 1 as the setting of the sheet type (when the setting of the sheet type is neglected to be reset), a fixing temperature is set higher than a proper temperature for the plain paper and printing speed is low speed proper for the thick paper. Under these conditions, a recording operation is performed. In this case, there is concern in that, for example, performance falls, a printing quality is deteriorated, curl of sheets is sometimes worsened, and a jam is caused.

Usually, information such as a brand, a size, a basis weight, presence or absence of surface coat, and the like is displayed on sheets in a packaged state. However, concerning required items of setting information on an image forming apparatus side, a user needs to translate the respective items and set, on the apparatus side, information such as whether a sheet is within a range of the thick paper 1, whether the sheet is coat paper, and whether the coat paper is coated on one side or both sides.

### BRIEF SUMMARY OF THE INVENTION

It is an object of the invention to provide an image forming apparatus and an image forming method that are capable of forming an image under appropriate image forming conditions corresponding to characteristics of an image recording medium with simple operation.

An image forming apparatus according to an aspect of the invention includes a storing unit configured to store an identification code of an image recording medium and an image forming condition in association with each other, a setting unit configured to set the identification code, and an image forming unit configured to form an image on the basis of the image forming condition associated with the identification code set by the setting unit.

An image forming method according to an aspect of the invention includes setting an identification code of an image recording medium, referring to information in which an identification code of the image recording medium and an image forming condition are stored in association with each other, and forming an image on the basis of the image forming condition associated with the identification code set.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view for showing a schematic structure of an image forming apparatus in an example of an embodiment of the invention;

FIG. 2 is a block diagram for explaining functions of the image forming apparatus in the example of the embodiment;

FIG. 3 is a flowchart showing processing for setting an identification code in the example of the embodiment;

FIG. 4 is a diagram showing an example of a display screen displayed as guidance on an operation panel according to a step of the flowchart in FIG. 3;

FIG. 5 is a diagram showing an example of a display screen displayed as guidance on the operation panel according to a step of the flowchart in FIG. 3;

FIG. 6 is a diagram showing an example of a display screen displayed as guidance on the operation panel according to a step of the flowchart in FIG. 3;

FIG. 7 is a diagram showing an example of a display screen displayed as guidance on the operation panel according to a step of the flowchart in FIG. 3;

FIG. 8 is a diagram showing an example of a display screen displayed as guidance on the operation panel according to a step of the flowchart in FIG. 3;

FIG. 9 is a diagram showing an example of a display screen displayed as guidance on the operation panel according to a step of the flowchart in FIG. 3;

FIG. 10 is a diagram showing an example of a display screen displayed as guidance on the operation panel according to a step of the flowchart in FIG. 3;

FIG. 11 is a diagram showing an example of a display screen displayed as guidance on the operation panel according to a step of the flowchart in FIG. 3;

FIG. 12 is a diagram showing an example of a display screen displayed as guidance on the operation panel according to a step of the flowchart in FIG. 3;

FIG. 13 is a diagram showing an example of a display screen displayed as guidance on the operation panel according to a step of the flowchart in FIG. 3;

FIG. 14 is a diagram showing an example of a procedure for setting sheets of a predetermined size in a sheet cassette;

FIG. 15 is a diagram showing the example of the procedure for setting sheets of the predetermined size in the sheet cassette;

FIG. 16 is a diagram showing the example of the procedure for setting sheets of the predetermined size in the sheet cassette;

FIG. 17 is a diagram showing the example of the procedure for setting sheets of the predetermined size in the sheet cassette;

FIG. 18 is a diagram showing the example of the procedure for setting sheets of the predetermined size in the sheet cassette;

FIG. 19 is a diagram showing the example of the procedure for setting sheets of the predetermined size in the sheet cassette;

FIG. 20 is a diagram showing the example of the procedure for setting sheets of the predetermined size in the sheet cassette; and

FIG. 21 is a diagram showing an example of sheet types that can be used in the image forming apparatus shown in FIG. 1.

### DETAILED DESCRIPTION OF THE INVENTION

Embodiments of the invention will be hereinafter explained with reference to the drawings.

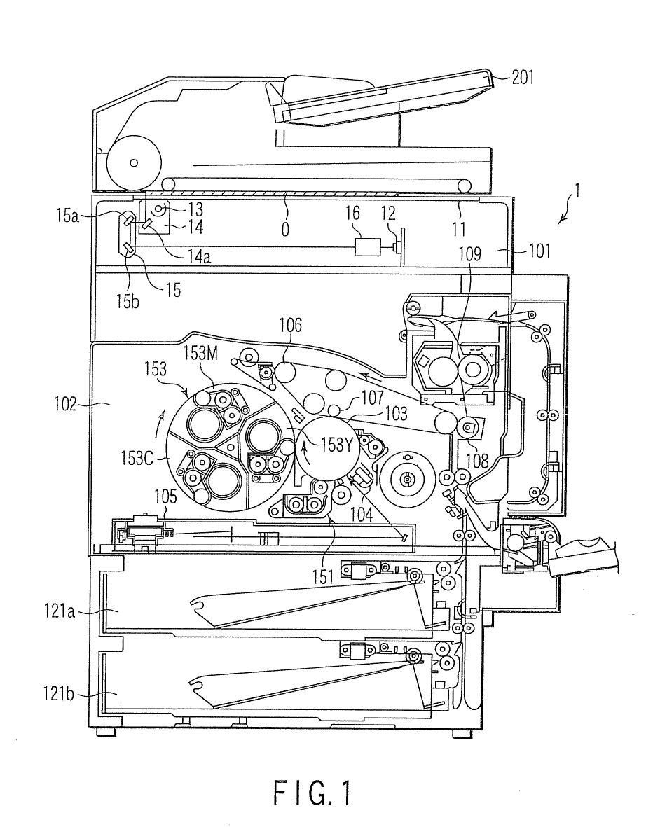

FIG. 1 is a schematic diagram showing an example of an image forming apparatus.

An image forming apparatus 1 includes a scanner unit 101 that scans image information held by copy objects O as light and shade and generates an image signal and a color printer unit 102 that forms an image corresponding to an image signal supplied from the scanner unit 101 or the outside. The scanner unit 101 is integrally provided with an automatic document feeder (ADF) 201 that replaces, when the copy objects O are sheet-like objects, the copy objects O in order according to a scanning operation for scanning the image information from the copy objects O.

The scanner unit 101 is formed of a material represented by glass or the like and transmitting light and has a transparent tabular original table 11 having generally uniform thickness. In a predetermined position below the original table 11 and inside the scanner unit 101, a CCD sensor 12 that converts image information of the originals O transmitted as image light described later into an electric signal (an image signal) is provided.

The CCD sensor 12 is, for example, a complex CCD sensor (a 4-line CCD sensor) in which a line CCD sensor for color (hereinafter referred to as color sensor), which has integrally formed therein three line sensors for detecting a color image (reflection from the originals O) as three primary colors of additive color mixture, R (red), G (green), and B (blue), and a line sensor for monochrome (achromatic color) (hereinafter referred to as monochrome sensor) are provided in parallel.

It is known that the CCD sensor 12 can secure high sharpness when a monochrome image is scanned compared with the well-known 3-line CCD sensor for color and has high stability (reproducibility) when an identical image is scanned plural times. Since the monochrome sensor and the color sensor are provided independently, the respective sensors (single line sensors) have equivalent scanning performance.

In a space below the original table 11, a lighting device 13 that lights the originals O set on the original table 11, a first carriage 14 that moves the lighting device 13 along the original table 11, and a second carriage 15 that guides image light, which is explained below, extracted by the first carriage 14 to the CCD sensor 12 are provided.

An example of an operation for copying an image of an original on the basis of image information scanned by the scanner unit 101 will be explained.

Following copying of image information, i.e., scanning of an original set on the ADF 201, when image formation and output (copy) are designated, a predetermined potential is given to a photoconductive drum 103 of the color printer unit 102 of the image forming apparatus 1 shown in FIG. 1 by a charging device 104 at predetermined timing after the image information of the original is scanned (or during a scanning operation).

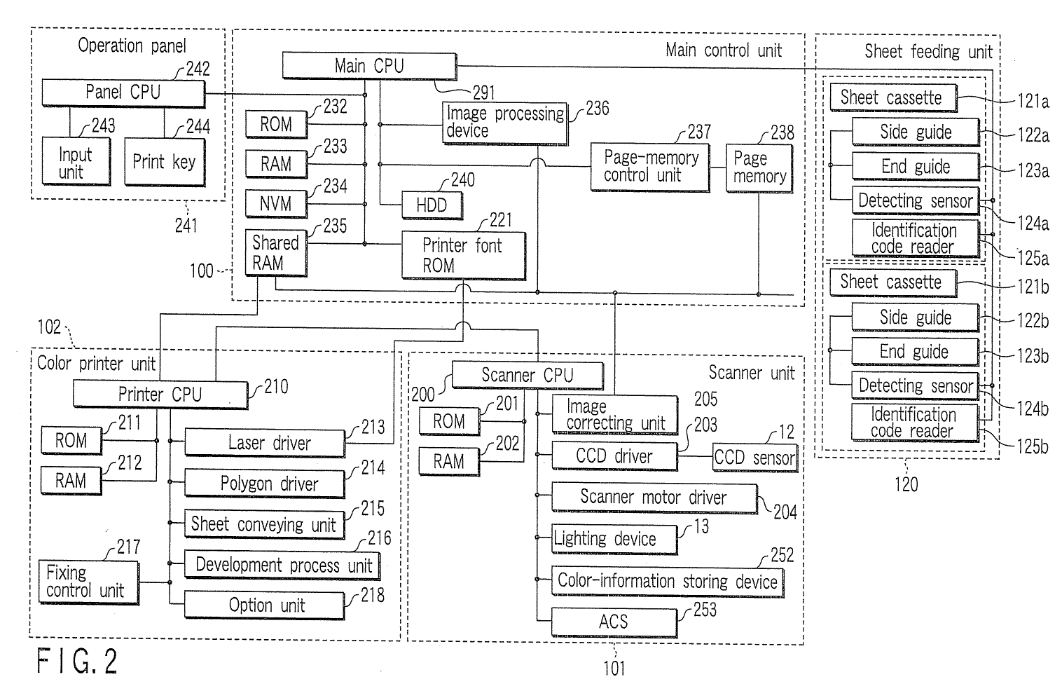

As shown in FIG. 2, an output of the CCD sensor 12 is inputted to an image correcting unit 205. The image correcting unit 205 has plural amplifiers that amplify image signals outputted from a line sensor for R, a line sensor for G, a line sensor for B, and a line sensor for black of the CCD sensor 12, respectively, (outputs of the line sensors) to a predetermined level, plural A-D conversion/threshold circuits that threshold the image signals amplified by the respective amplifiers at a predetermined threshold level and convert the image signals into digital signals, and an image processing circuit that subjects the respective image signals thresholded to image processing in accordance with a rule decided in advance.

When the originals (the copy objects) O are sheet like objects and conveyed to the scanner unit 101 in order by the ADF 201 and when, for example, originals including color images and originals including only monochrome images are mixed, outputs of the CCD sensor 12 with, for example, a color balance and densities of respective color components corrected in the image processing circuit are identified by an ACS (automatic color determining circuit) 253 to find whether the originals are originals including color images or originals including only monochrome images and stored in a color-information storing device 252 in association with the information of the identification and an order of the originals O, i.e., an order of pages stacked on the ADF 201.

Thereafter, image data corresponding to images of the originals O scanned by the scanner unit 101 are supplied to a page memory 238 and image data for one page is arranged. Processing for accumulating the image data in the page memory 238 will be explained in detail later. When the image data for one page is arranged on the page memory, an electrostatic latent image is formed in a predetermined position of the photoconductive drum 103, to which a predetermined potential is already given from an exposing device 105, on the basis of the image data held by the page memory 238 and an image is printed on a sheet supplied from a sheet cassette 121a or 121b.

FIG. 2 is a block diagram schematically showing a flow of a signal for electric connection and control of the image forming apparatus shown in FIG. 1. As shown in FIG. 1, the image forming apparatus mainly includes four CPUs, namely, a main CPU 291 in a main control unit 100, a panel CPU 242 in an operation panel 241, a printer CPU 210 in the color printer unit 102, and a scanner CPU 200 in the scanner unit 101.

To the panel CPU 242 that controls the entire operation panel 241, a print key 244 for instructing start of copy, an input unit 243 provided with, for example, plural push button switches or a touch sensor panel for inputting conditions for image output in a digital copying machine, for example, the number of copies or prints and a magnification or designation of a partial copy and coordinates of an area of the partial copy, a ten key used for setting the number of copies, and the like are connected.

To the main CPU 291 that controls the entire main control unit 100, a ROM 232, a RAM 233, an NVM 234, a shared RAM 235, an image processing device 236, a page-memory control unit 237, an HDD 240, a printer font ROM 221, and the like are connected.

The ROM 32 has a control program stored therein and the RAM 233 temporarily stores data. The NVM 234 is a nonvolatile memory backed up by a battery and adapted such that data on the NVM 234 is not lost even if a power supply is turned off. The shared RAM 235 is used for performing bidirectional communication between the main C 291 and the printer CPU 210. The page-memory control unit 237 stores image information in and reads out image information from the page memory 238. The page memory 238 has an area enough for storing image information for plural pages and is formed to be capable of storing, page by page, data obtained by compressing image information from the scanner unit 101. Font data corresponding to print data is stored in the printer font ROM 221.

To the printer CPU 210 that controls the color printer unit 102, a ROM 211 having stored therein a control program, a RAM 212 for data storage, a laser driver 213 that turns on and off light emission by a semiconductor laser, a polygon motor driver 214 that controls rotation of a polygon motor, a sheet conveying unit 215 that manages sheet conveyance processing, a development process unit 216 that manages development processing, a fixing control unit 217 that manages fixing processing, an option unit 218, and the like are connected.

To the scanner CPU 200 that controls the scanner unit 101, a ROM 201 having stored therein a control program, a RAM 202 for data storage, a CCD driver 203 that drives the CCD sensor 12, a scanner motor driver 204 that controls rotation of a motor for moving an image scanner (carriage), the lighting device 13 for lighting an original to be scanned and the like, the image correcting unit 205 that performs various kinds of image correction including shading correction, and the like are connected.

The scanner CPU 200 controls the scanner motor by performing setting of various signals in the scanner motor driver 204. Expansion and reduction of an image scan image are performed according to an input magnification set by a user using the input unit 243. Reflection of an input magnification in a main scanning direction (a CCD line sensor direction) is realized by the main CPU 291 setting a magnification in the image processing device 236. As reflection of an input magnification in a sub-scanning direction (an image scanner moving direction), expansion and reduction are realized by changing moving speed of the image scanner (carriage) for scanning. In other words, rotation speed of the image scanner motor is changed according to a pulse (clock) for driving of the scanner motor designated to the scanner motor driver 204 by the scanner CPU 200 and an exciting system to be set.

A sheet feeding unit 120 includes the sheet cassettes 121a and 121b. The sheet cassette 121a or 121b is selected in response to a cassette selection instruction from the operation panel 241. The sheet cassette 121a includes a side guide 122a and an end guide 123a and further includes a detecting sensor 124a that detects positions of the side guide 122a and the end guide 123a. The detecting sensor 124a detects a size of sheets set in a state in which the sheets are guided by the side guide 122a and the end guide 123a and notifies the main CPU 291 of a detection result.

Similarly, the sheet cassette 121b includes a side guide 122b and an end guide 123b and further includes a detecting sensor 124b that detects positions of the side guide 122b and the end guide 123b. The detecting sensor 124b detects a size of sheets set in a state in which the sheets are guided by the side guide 122b and the end guide 123b and notifies the main CPU 291 of a detection result.

The sheet cassette 121a may include an identification code reader 125a. In this case, the sheet cassette 121a is configured to store sheets together with a sheet package (configured to store sheets in a state in which the sheets are partially wrapped by the sheet package). The identification code reader 125a can optically read an identification code recorded in the package set in the sheet cassette 121a.

Similarly, the sheet cassette 121b includes an identification code reader 125b. In this case, the sheet cassette 121b is configured to store sheets together with a sheet package (configured to store sheets in a state in which the sheets are partially wrapped by the sheet package). The identification code reader 125b can optically reads an identification code recorded in the package set in the sheet cassette 121b.

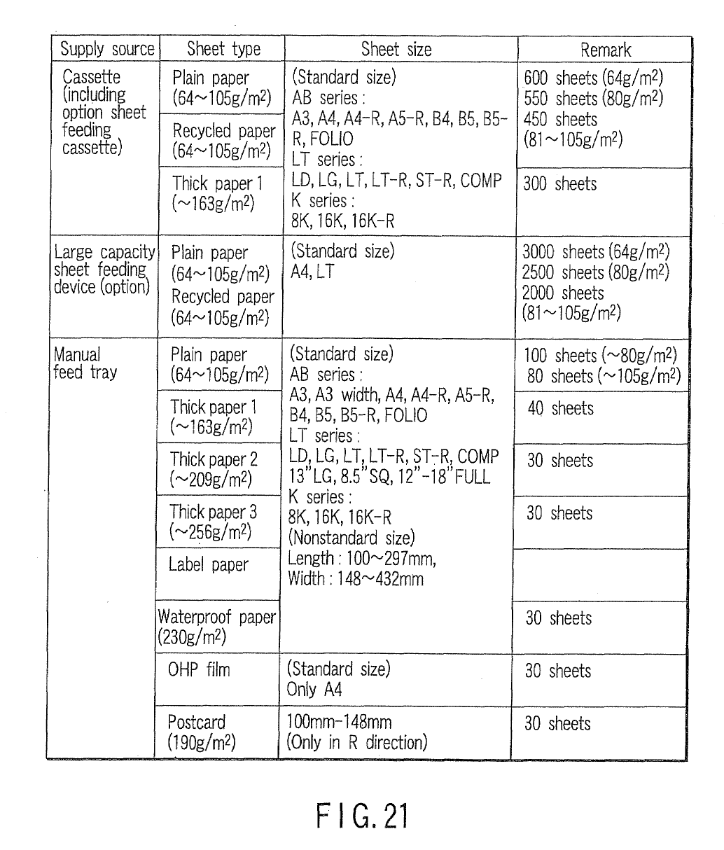

Appropriate image formation corresponding to characteristics of an image recording medium (a sheet) based on the identification code realized in the image forming apparatus described above will be hereinafter explained. Types of sheets that can be used in the image forming apparatus are, for example, as shown in FIG. 21.

The NVM 234 stores identification codes of sheets and image forming conditions (a development condition, a transfer condition, a fixing temperature condition, etc.) in association with each other. The operation panel 241 displays plural kinds of identification codes of sheets and sets one of the plural kinds of identification codes in response to input operation of the user. Alternatively, the scanner unit 101 reads an identification code attached to a sheet package or the like and sets the identification code read. Alternatively, the identification code readers 125a and 125b read an identification code attached to a sheet package or the like and set the identification code read. The color printer unit 102 sets image forming conditions associated with the identification code set and forms an image on the basis of the image forming conditions.

The image formation using the identification code will be explained more in detail. For example, plural identification codes corresponding to thin paper, plain paper, thick paper 1, thick paper 2, thick paper 3, one side coat paper, both side coat paper, label paper, and the like are registered and image forming conditions (a development condition, a transfer condition, a fixing temperature condition, etc.) are registered in association with these plural identification codes. Even if image forming conditions are registered once, it is possible to change the setting of the image forming conditions as required.

In designating a type of sheets, for example, the user selects a desired identification code from a list of identification codes of sheets displayed on the operation panel 241. Alternatively, the user reads an identification code (a barcode) attached to a sheet package or the like using the scanner unit 101. Alternatively, the user reads the identification code (the barcode) attached to the sheet package or the like using the identification code readers 125a and 125b. It is also possible that a barcode reader is connected to the image forming apparatus and the identification code is read by this barcode reader.

Consequently, a size and a type of sheets are unconditionally designated according to the setting of the identification code. A sheet feeding condition, process speed, a fixing temperature condition, and the like are automatically set optimally.

When an unregistered identification code (unregistered sheets) is used, it is also possible to register the unregistered identification code anew. For example, the user inputs the unregistered identification code via the operation panel 241 and also inputs image forming conditions in association with this identification code inputted. Alternatively, the user reads the unregistered identification code with the scanner unit 101 and inputs image forming conditions in association with the identification code read.

It is possible to realize simplification of work for repeatedly inputting image forming conditions by using the identification code. A sheet size is unconditionally defined according to the setting of the identification code. For example, it is possible to detect mismatch of the sheet size designated by the identification code and a sheet size based on an output of the detecting sensor 124a or 124b (mismatch of the designated sheet size and a sheet size actually set). In this case, i.e., when mismatch of the sheet sizes is detected, the operation panel 241 can notify the user of a sheet setting error.

As an identification code of sheets, for example, an EAN code (European Article Number), a UPC (Universal Product Code), or a JAN (Japanese Article Number) is used. If an identification code is displayed on a sheet package, the user checks the identification code and selects and inputs the identification code via the operation panel 241 at a point when the user opens the sheet package and sets sheets. Alternatively, the user registers an identification code anew.

Since the EAN code is formed as a barcode, a barcode reading function (the scanner unit 101 and the identification code readers 125a and 125b) may be mounted on the image forming apparatus to read and set the EAN code with this barcode reading function. For example, the user may read the identification code using the original scanning function of the scanner unit 101. In other words, the user only has to place a barcode display section of the sheet package on the original table 11 and causes the scanner unit 101 to read the identification code. Alternatively, the user reads an identification code (a barcode) attached to a sheet package or the like using the identification code readers 125a and 125b.

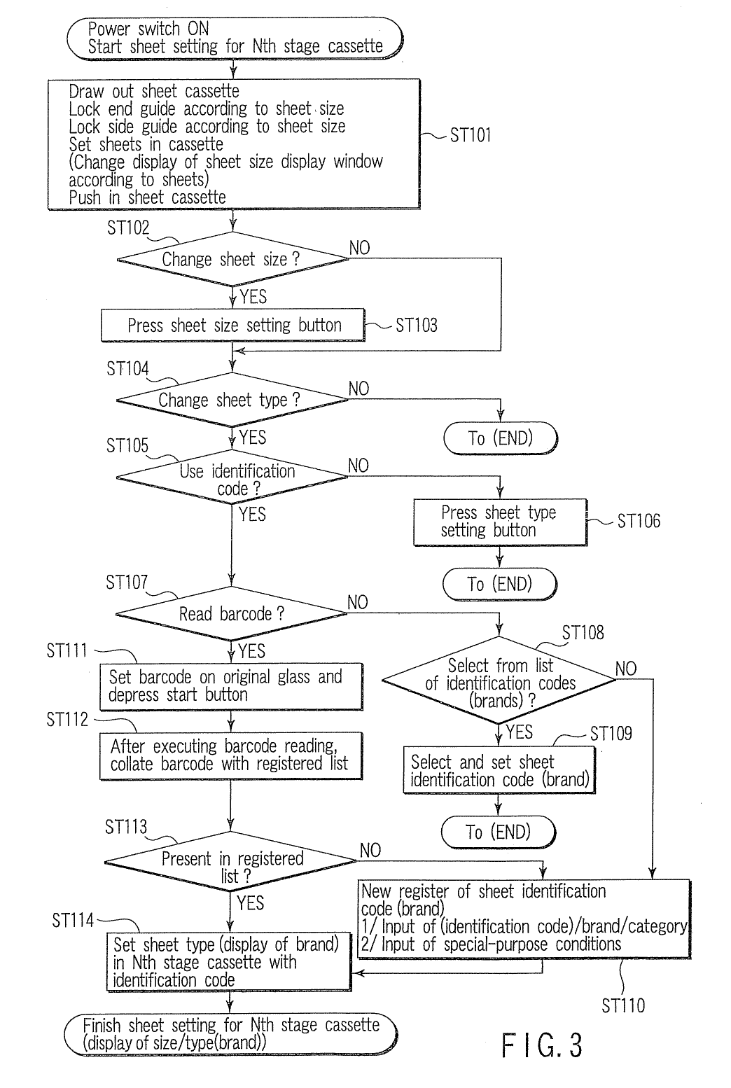

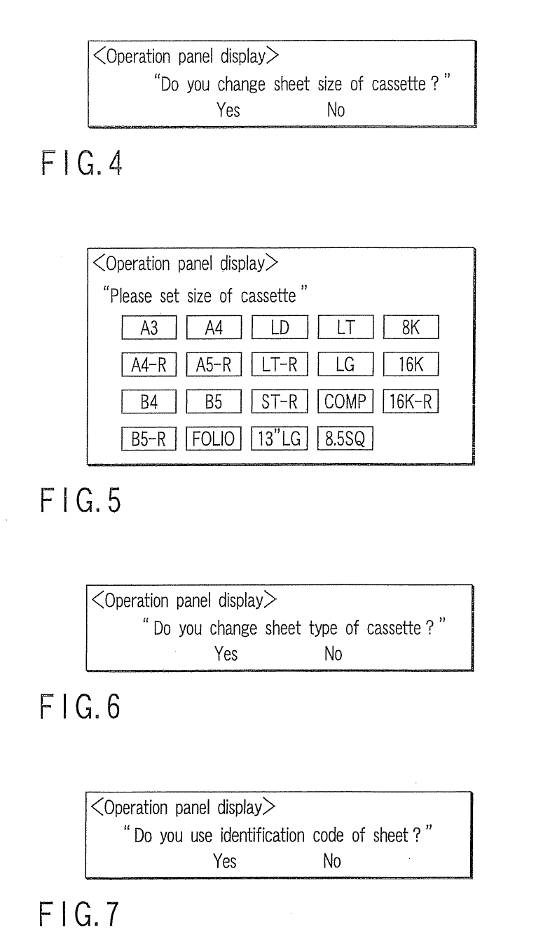

FIG. 3 is a flowchart showing an example of processing for setting an identification code. FIGS. 4 to 13 are diagrams showing examples of a display screen displayed as guidance on the operation panel 241 according to the respective steps of the flowchart in FIG. 3.

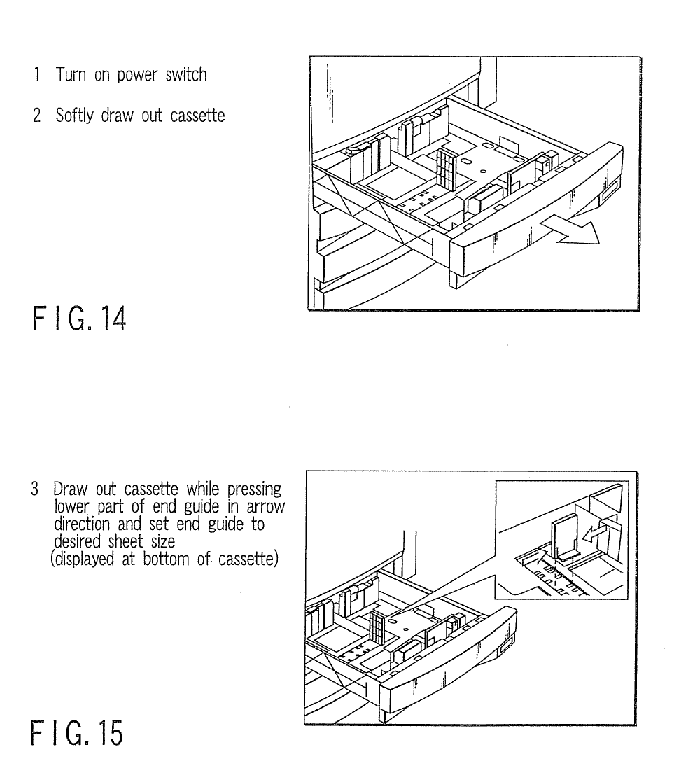

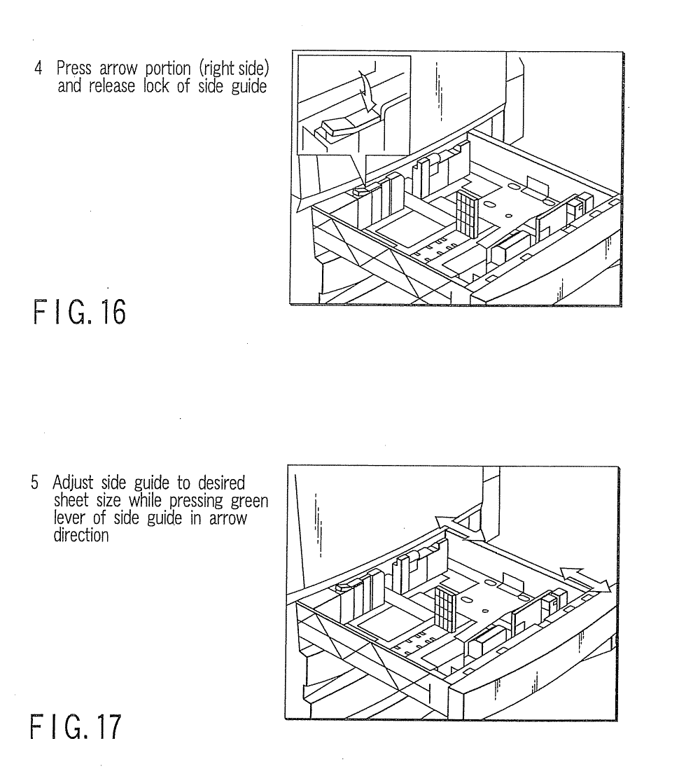

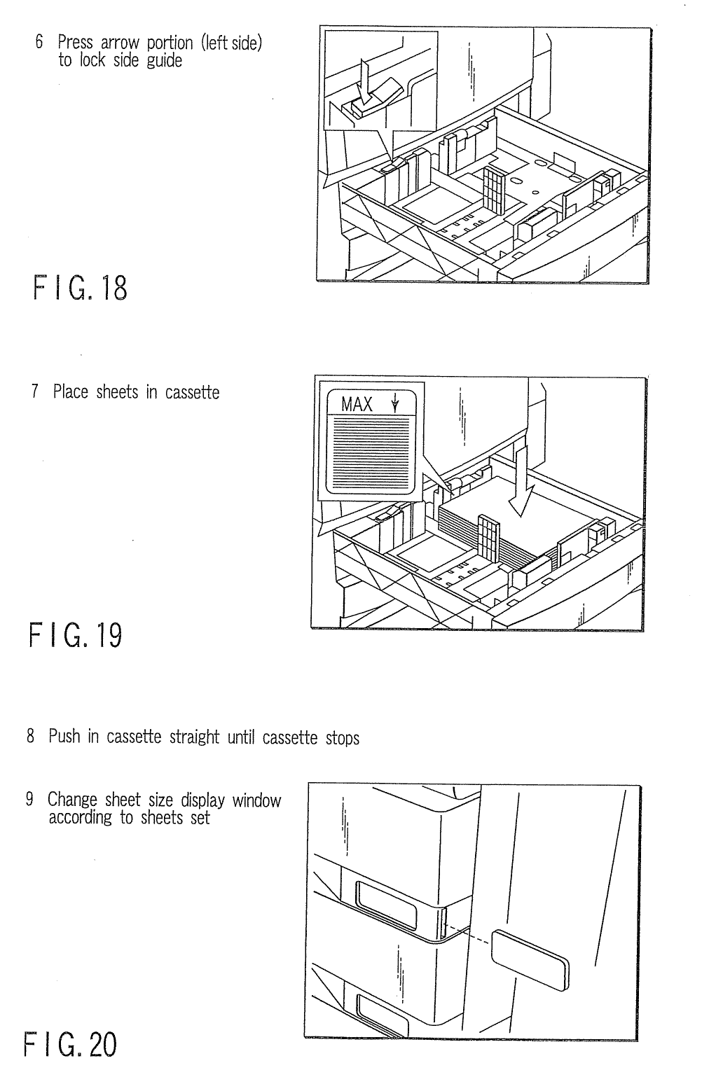

As shown in FIGS. 14 to 20, the user draws out the sheet cassette 121a or 121b and, in order to set sheets of a predetermined size, changes positions of the end guide 123a or 123b and the side guide 122a or 122b, and sets the sheet of the predetermined size (ST101).

When the user pushes in the sheet cassette 121a or 121b, a guide screen shown in FIG. 4 is displayed on the operation panel 241. When the user changes the sheet size (ST102, YES), the user designates sheet size change via the guide screen shown in FIG. 4 (touches a display item “Yes”).

Subsequently, a guide screen shown in FIG. 5 is displayed on the operation panel 241. When a predetermined sheet size button is touched via the guide screen shown in FIG. 5 (ST103), a predetermined sheet size is set.

Subsequently, a guide screen shown in FIG. 6 is displayed on the operation panel 241. When the user changes a sheet type (ST104, YES), the user designates a sheet type change via the guide screen shown in FIG. 6 (touches a display item “Yes”).

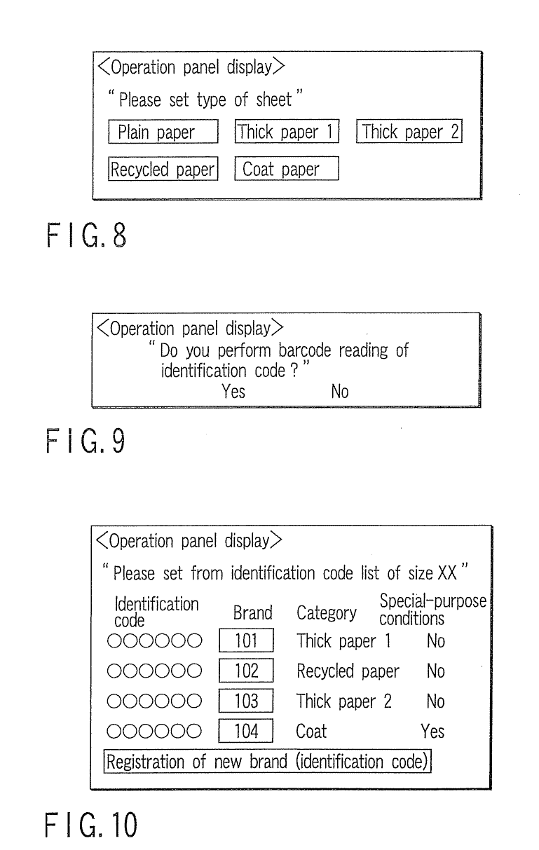

Subsequently, a guide screen shown in FIG. 7 is displayed on the operation panel 241. When an identification code is not used (ST105, NO), the user designates nonuse of the identification code via the guide screen shown in FIG. 7 (touches a display item “No”). In response to the designation, a guide screen shown in FIG. 8 is displayed on the operation panel 241. When a predetermined sheet type setting button is touched (ST106), a predetermined sheet type is set.

When an identification code is used (ST105, YES), the user designates use of the identification code via the guide screen shown in FIG. 7 (touches a display item “Yes”). In response to the designation, a guide screen shown in FIG. 9 is displayed on the operation panel 241. When reading of the identification code (a bar code) is not performed (ST107, NO), the user designates, via the guide screen shown in FIG. 9, that the identification code is not read (touches a display item “No”). In response to the designation, a guide screen shown in FIG. 10 is displayed on the operation panel 241. When a predetermined identification code setting button is touched (ST108, YES), a predetermined identification code is set (ST109).

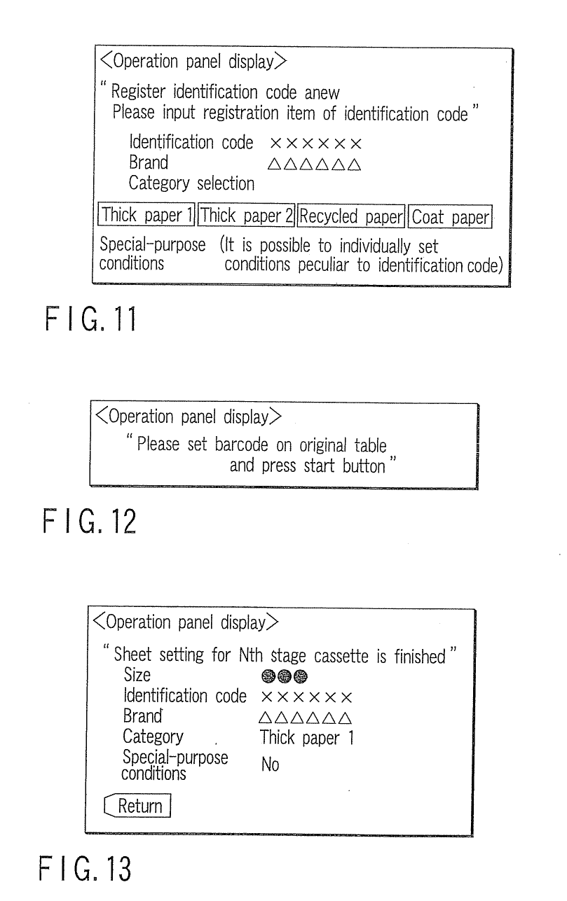

When an identification code corresponding to the identification code setting button is not present (ST108, NO), the user can register an identification code anew via the guide screen shown in FIG. 10. For example, when the user selects an item of new registration on the guide screen shown in FIG. 10, a guide screen shown in FIG. 11 is displayed and the user can register an identification code anew (ST110).

When reading of the identification code (the barcode) is performed (ST107, YES), the user designates, via the guide screen shown in FIG. 9, that the identification code is read (touches a display item “Yes”). In response to the designation, a guide screen shown in FIG. 12 is displayed. The user sets an identification code attached to a sheet package on the original table 11 and designates start of reading (ST111). When the identification code read has been registered (ST112) (ST113, YES), setting contents are displayed on a guide screen shown in FIG. 13 and the setting is completed (ST114).

If the identification code is an EAN code, a structure of the identification code is (country code)+(manufacturer code)+(commodity item code). Thus, the identification code is a code peculiar to a recording medium. A brand is a product name and product number of sheets as a commodity. A category indicates a type of the sheets, for example, plain paper, thick paper 1, thick paper 2, recycled paper, or coat paper.

In the example of the guide screen in FIG. 11, plain paper is treated without an identification code. When general-purpose recording conditions for the respective categories are applied to an identification code, it is unnecessary to perform input specific to special-purpose conditions. When it is desired to set, for the identification code, recording conditions partially different from the general-purpose conditions for the categories, it is possible to set the special-purpose conditions. For example, when a sheet is classified into the thick paper 1 as a category, it is possible to perform, for example, higher fixing temperature setting slightly close to the thick paper 2. Concerning the sheet feeding condition, the development condition, the transfer condition, and the like, it is possible to set special-purpose conditions according to an identification code.

An identification code may be read in a sheet cassette or may be read by a special-purpose identification code reader rather than simply reading the identification code in the position of the original table 11. There is no special restriction on an installation position of the identification code reader.

If an identification code attached to a sheet package is in an easily separable state, the identification code separated is set in a reading position of the identification code reader and reading of the identification code is executed. Alternatively, the identification code reader may be provided in the sheet cassette to read the identification code attached to the sheet package that is set together with sheets. More specifically, identification code readers 125a and 126b are installed in the end guides 123a and 123b in the sheet cassettes 121a and 121b and sheets of one package are set in the cassette integrally with a package partially left in positions opposed to the end guides 123a and 123b. By reading an identification code on the package partially left in the positions opposed to the end guides 123a and 123b, it is possible to set an identification code at the time when the sheets are set.

As described above, when sheets in the A4 plain sheet cassette are temporarily changed to thick paper and print-outputted and, after the output, the thick paper is changed back to the plain paper, the following work is performed. A setting of the cassette is once changed from the plain paper to the thick paper, print conditions such as a fixing temperature are changed, and, after print work with the thick paper is finished, the setting is changed back from the thick paper to the plain paper.

As a cause of complaints to paper wrinkle and the like, there is inappropriate setting of image forming conditions for sheets. If rationalization of setting work by the user at the time of sheet replacement can be realized, it is possible to reduce such complaints. The image forming apparatus explained in this embodiment can manage image recording media with peculiar identification codes for each type of the image recording media and automatically set image forming conditions for each of the identification codes. Consequently, it is possible to rationalize setting work for image forming conditions and realize reduction in frequency of occurrence of troubles.

It is necessary to set image forming conditions anew for an image recording medium of a new type. However, once an identification code corresponding to the image recording medium of the new type and image forming conditions are set in association with each other (if the image recording medium was used in the past), setting of detailed image forming conditions does not have to be performed again. In other words, it is possible to read out image forming conditions on the basis of an identification code set in the past and form an image. As a result, setting work for the image forming conditions is rationalized.

This embodiment is summarized as follows.

(1) Image forming conditions are stored in association with identification codes of various image recording media to make it possible to set image forming conditions corresponding to the various image recording media with simple operation and realize reduction in setting work for image forming conditions at the time of sheet replacement.

(2) A barcode is adopted as an identification code of an image recording medium. A barcode reader may be used as means for inputting this barcode.

(3) Input of the identification code is not essential and input of a sheet size and a sheet type may also be used.

(4) As the input of the identification code, it is possible to select one of code input (ten key input) and barcode reading.

(5) A scanner for original scanning may be used as means for inputting the barcode.

(6) As a guidance for a setting procedure for an image recording medium, procedures for confirming, for example, whether an identification code (or brand selection corresponding to the identification code) should be inputted, whether the identification code should be optically read, whether an original scanning device (a scanner) should be used, and whether the identification code has been registered are prepared.

(7) It is possible to set sheet feeding conditions and process conditions (conditions for development, transfer, fixing, and the like) as peculiar conditions for each of identification codes registered. Therefore, by registering the identification codes, it is possible to set image forming conditions in a number equal to the number of the registered identification codes at the maximum. For special image recording media (e.g., waterproof paper), it is also possible to set image recording conditions for each of brands. Moreover, when it is necessary to set a new image recording condition for a new image recording medium, it is easy to cope with the setting.

Consequently, it is possible to realize rationalization of setting work by the user at the time of sheet replacement and it is possible to easily set detailed image forming conditions according to characteristics of various image recording media.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a storing unit configured to store an identification code of an image recording medium and an image forming condition in association with each other;
a setting unit configured to set the identification code; and
an image forming unit configured to form an image on the basis of the image forming condition associated with the identification code set by the setting unit.

2. An image forming apparatus according to claim 1, wherein the storing unit stores, for each of plural identification codes, image forming conditions including a development condition, a transfer condition, and a fixing temperature condition.

3. An image forming apparatus according to claim 1, wherein the setting unit displays plural kinds of identification codes of image recording media and sets one identification code out of the plural kinds of identification codes according to input operation by a user.

4. An image forming apparatus according to claim 1, wherein the setting unit optically reads an identification code and sets the identification code read.

5. An image forming apparatus according to claim 1, comprising a scanning unit configured to optically scan an original image, wherein
the setting unit optically scans an identification code with the scanning unit and sets the identification code scanned.

6. An image forming apparatus according to claim 1, comprising:
a storing unit configured to store image recording media together with a package of the image recording media; and
a reading unit configured to optically read an identification code recorded in the package stored in the storing unit, wherein
the setting unit sets the identification code read by the reading unit.

7. An image forming apparatus according to claim 1, comprising:
plural storing units configured to store image recording media together with packages of the image recording media; and
plural reading units configured to optically read identification codes recorded in the packages stored in the plural storing units, respectively, wherein
the setting unit sets one storing unit out of the plural storing units according to input operation by a user and sets an identification code read by one reading unit corresponding to the storing unit set, and
the image forming unit takes out an image recording medium stored in the one storing unit set by the setting unit and forms, on the basis of image forming conditions associated with the identification code set by the setting unit, an image on the image recording medium taken out.

8. An image forming apparatus according to claim 1, comprising:
a detecting unit configured to detect a size of an image recording medium; and
a notifying unit configured to notify an error on the basis of mismatch of a size detected by the detecting unit and a size identified from the identification code set by the setting unit.

9. An image forming method comprising:
setting an identification code of an image recording medium; and
referring to information in which an identification code of the image recording medium and an image forming condition are stored in association with each other, and forming an image on the basis of the image forming condition associated with the identification code set.

10. An image forming method according to claim 9, wherein plural kinds of identification codes of image recording media are displayed and one identification code is set out of the plural kinds of identification codes according to input operation by a user.

11. An image forming method according to claim 9, wherein an identification code is optically read and the identification code read is set.

12. An image forming method according to claim 9, comprising setting an identification code read by a reading unit configured to optically read an identification code recorded in a package stored in a storing unit configured to store image recording media together with a package of the image recording media.

13. An image forming method according to claim 9, comprising:
setting, according to input operation by a user, one storing unit out of plural storing units configured to store image recording media together with packages of the image recording media and setting an identification code read by one reading unit corresponding to the storing unit set among plural reading units configured to optically read an identification code recorded in a packages stored in each of the plural storing units, and
taking out an image recording medium stored in the one storing unit set by the setting unit and forming, on the basis of image forming conditions associated by the identification code set by the setting unit, an image on the image recording medium taken out.

14. An image forming method according to claim 9, comprising:
detecting a size of an image recording medium; and
notifying an error on the basis of mismatch of a size detected and a size identified from the identification code set.

15. An image forming apparatus comprising:
storing means for storing an identification code of an image recording medium and an image forming condition in association with each other;
setting means for setting the identification code; and
image forming means for forming an image on the basis of the image forming condition associated with the identification code set by the setting means.

16. An image forming apparatus according to claim 15, wherein the setting means displays plural kinds of identification codes of image recording media and sets one identification code out of the plural kinds of identification codes according to input operation by a user.

17. An image forming apparatus according to claim 15, wherein the setting means optically reads an identification code and sets the identification code read.

18. An image forming apparatus according to claim 15, comprising:
storing means for storing image recording media together with a package of the image recording media; and
reading means for optically reading an identification code recorded in the package stored in the storing means, wherein
the setting means sets the identification code read by the reading means.

19. An image forming apparatus according to claim 15, comprising:
plural storing means for storing image recording media together with packages of the image recording media; and
plural reading means for optically reading identification codes recorded in the packages stored in the plural storing means, respectively, wherein
the setting means sets one storing means out of the plural storing means according to input operation by a user and sets an identification code read by one reading means corresponding to the storing means set, and
the image forming means takes out an image recording medium stored in the one storing means set by the setting means and forms, on the basis of image forming conditions associated with the identification code set by the setting means, an image on the image recording medium taken out.

20. An image forming apparatus according to claim 15, comprising:
detecting means for detecting a size of an image recording medium; and
notifying means for notifying an error on the basis of mismatch of a size detected by the detecting means and a size identified from the identification code set by the setting means.
